(19) United States
(12) Patent Application Publication
(10) Pub. No.: US 2009/0161705 A1
(43) Pub. Date: Jun. 25, 2009

(54) Laser projection utilizing beam misalignment

(76) Inventors: Etienne Almoric, Avon Cedex (FR); Jacques Gollier, Painted Post, NY (US); James Martin Grochocinski, Newfield, NY (US)

Correspondence Address: CORNING INCORPORATED, SP-TI-3-1, CORNING, NY, 14831, US

(21) Appl. No.: 12/004,181

(22) Filed: Dec. 20, 2007

(51) Int. Cl. H01S 3/10; G02B 26/08

(52) U.S. Cl. 372/24

(57) ABSTRACT

A laser projection system is provided comprising a laser source, projection optics, scanning optics, and a scanning controller. The laser source comprises at least two punctual sources P1, P2 configured to generate two optical beams. The scanning controller is configured to drive the scanning optics to define a fast scanning axis direction in which lines of an image are projected and a slow scanning axis direction in which the optical beams address successive lines of the projected image. The position of the respective punctual sources relative to each other and to an optical axis of the projection optics provides an angular misalignment of the first and second optical beams downstream of the projection optics. The respective punctual sources are positioned such that the first and second optical beams are misaligned in the slow scanning axis direction to a greater extent than in the fast scanning axis direction.

### BACKGROUND OF THE INVENTION

The present invention relates to scanning laser projection systems and methods of laser projection utilizing a plurality of optical beams characterized by different wavelength spectrums. More specifically, the present invention relates to the design and operation of projection systems that improve the eye safety margins of laser projectors while avoiding or at least minimizing image degradation during laser projection.

### BRIEF SUMMARY OF THE INVENTION

Many safety regulations governing the design and operation of scanning laser projection systems establish a maximum laser power exposure threshold that should not be exceeded during scanning operations. These exposure limits are often related to the class of laser in use. According to one set of safety standards, if the projection system utilizes a succession of laser pulses to project an image, and if the pulses irradiate the eye of a viewer over an irradiation period of 18 microseconds or less, then the collective contribution of each pulse within the succession of pulses must be accounted for in determining whether the safety limit has been exceeded. Accordingly, in many cases, it will be necessary to establish a minimum inter-pulse delay, i.e., the delay between pulses, to satisfy particular safety limits, often referred to as eye damage time constants.

Once a suitable inter-pulse delay is established, laser safety can be assessed by accounting for total pulse duration over a given window of time, often referred to as total-on-time-pulse (TOTP). TOTP can be calculated as the sum of the duration of all pulses over a given window of time, e.g., 0.25 seconds. The accessible emission limit (AEL) of the projection system is exponentially proportional to the TOTP, so any increase in TOTP will significantly increase the AEL. For multi-color laser projection systems, the TOTP must be accumulated for each of the projected colors. As a result, a number of schemes have been proposed for angularly misaligning the respective beams of each color used in the projection system to generate a projected image. An example of one such system is presented in U.S. Pat. No. 7,255,445, assigned to the Sony Corporation.

Many scanning laser projection systems employ a scanning mirror or some type of optical configuration that is driven to create a scanned laser image by scanning the respective beams of different color in a fast scanning axis direction in which lines of an image are projected and a slow scanning axis direction in which the optical beams address successive lines of the projected image. The present inventors have recognized that, where multiple beams are misaligned in the direction of the slow scanning axis, the optical beams can be misaligned in the slow scanning axis direction to increase the duration of time the eye may be exposed to the optical beams. In one embodiment of the present invention, respective deflections of the different optical beams are misaligned in the slow scanning axis direction by between approximately one half of the angular extent of a standard eye pupil and approximately one full angular extent of a standard eye pupil and by a scanning interval greater than a given eye damage time constant.

Typically, an inter-pulse delay must be introduced in the scanning operation to misalign the optical beams. This delay can decrease the duty factor of the scanner and, therefore, decrease the total power on the projection screen. Accordingly, the present inventors have recognized a need to minimize the angular misalignment of the optical beams.

According to one embodiment of the present invention, a laser projection system is provided comprising a laser source, projection optics, scanning optics, and a scanning controller. The laser source is made of at least two close emitting punctual sources that can be, for instance two laser diodes on the same single chip. The optical configuration of the projector is then calculated to provide both functions of beam shaping and provide the minimum angular separation that is needed to improve the exposure limit.

### BRIEF DESCRIPTION OF THE SEVERAL VIEWS OF THE DRAWINGS

The following detailed description of specific embodiments of the present invention can be best understood when read in conjunction with the following drawings, where like structure is indicated with like reference numerals and in which:

FIGS. 1A and 1B are general schematic illustration of a laser projection system according to one embodiment of the present invention;

FIGS. 2-4 are schematic illustrations of respective deflections of two angularly misaligned optical beams in an image plane; and

FIG. 5 is an illustration of distortion in a scanned laser image.

### DETAILED DESCRIPTION

In the following detailed description, reference is made to the accompanying drawings that form a part hereof, and in which are shown by way of illustration, and not by way of limitation, specific embodiments in which the invention may be practiced. It is to be understood that other embodiments may be utilized and that changes may be made without departing from the spirit and scope of the present invention.

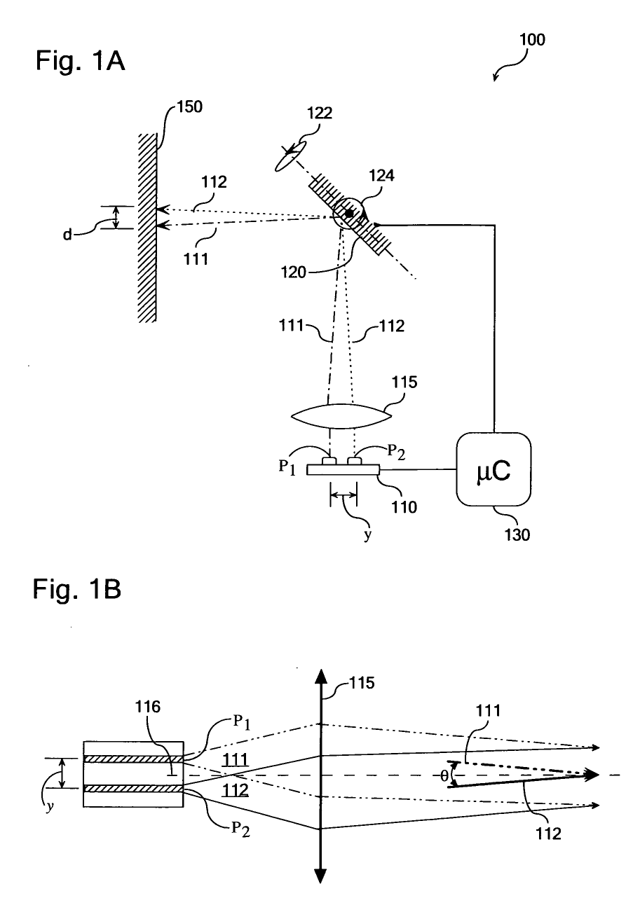

FIGS. 1A and 1B are general schematic illustrations of a laser projection system 100 according to one embodiment of the present invention. The laser projection system 100 comprises a laser source 110, projection optics 115, scanning optics 120, and a scanning controller 130. Generally, the laser source 110 comprises a multi-emitter laser source and is configured to produce first and second optical beams 111, 112, although three beam systems are also contemplated, particularly where the projection system 100 is configured as a multi-color projector, such as an RGB projection system. The two emitters P1 and P2 may comprise, for example, a double emitter laser with two emitting points located on the same chip, or a multiple emitter frequency doubled laser. The two emitters P1 and P2 may have the same wavelengths and can be modulated individually. In another case, P1, P2, and potentially P3, can be made of different laser chips integrated very close together and having distinct wavelength spectrums, i.e., different emission wavelengths. As an example and not by way of limitation, the laser source 110 may comprise three distinct emitters, one for each of three distinct emission colors.

In the illustrated embodiment the scanning optics 120 is presented in the form of a scanning mirror which may comprise, for example, a two-axis, gimbal-mounted, MEMS scanning mirror that deflects the optical beams 111, 112 through a deflection angle of about +/−60 degrees about two orthogonal scanning axes 122, 124. Although the various embodiments of the present invention are described herein with reference to a scanning mirror 120, it is contemplated that a variety of conventional or yet to be developed optical configurations may be employed to form suitable scanning optics for practicing the present invention.

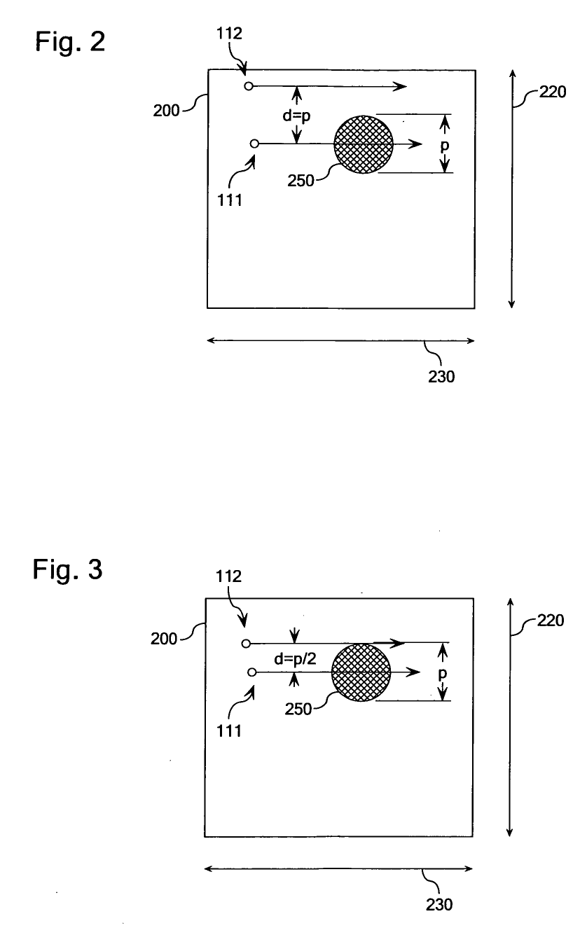

Referring collectively to FIGS. 1A and 2, regardless of the nature of the particular wavelength spectra of the two optical beams 111, 112, the scanning controller 130 is configured to drive the scanning mirror 120 in a slow scanning axis direction 220 and a fast scanning axis direction 230. In addition, the laser source 110, the projection optics 115, and the scanning mirror 120 are configured such that the first and second optical beams 111, 112 strike the scanning mirror 120 at different angles of incidence in a slow scanning plane defined by movement of the scanning mirror 120 in the slow scanning axis direction 220. Preferably, although not required, the first and second optical beams 111, 112 strike the mirror 120 at approximately identical positions. The deflected beams are directed towards an image plane 150 to generate an image 200, which is merely illustrated schematically in FIG. 2.

The role of the laser source 110 and the projection optics 115 in ensuring that the first and second optical beams 111, 112 strike the scanning mirror 120 at different angles of incidence is more thoroughly illustrated in FIG. 1B. As is illustrated in FIG. 1B, the positioning and orientation of the respective punctual sources P₁, P₂ of the first and second optical beams 111, 112, relative to the optical axis 116 of the projection optics 115, creates relative differences in the respective directions of propagation of the first and second optical beams 111, 112. The projection optics 115 and the laser source 110 can be configured to tailor this difference in propagation to generate suitable misalignment of the beams 111, 112 in the image plane 150.

In a relatively simple embodiment, the projection optics 115 comprises a single collimating lens and the angular separation 0 can be tailored by referring to the following relation, or a mathematical equivalent thereof:

θ=Δy/f

where Δy is the separation of the respective punctual sources of the first and second optical beams 111, 112 along an axis orthogonal to the propagation direction of the beams 111, 112 and f is the focal length of the lens 115. In laser projection systems, the focal length f of the nearly collimating lens 115 is dictated by the size of the spot that is desired in the image plane 150. Because the focal length f of the lens is typically fixed, in many cases, the angular separation θ of the beams 111, 112 can be adjusted by providing the laser source 110 with adjustable punctual sources and modifying the distance Δy between the punctual source emitters of the beams 111, 112. The adjustable punctual sources may be provided as independent emitters mounted on a common flame configured to permit independent positioning of the emitters, independently positionable emitters mounted to or formed on a laser chip, or any of a variety of alternative conventional or yet to be developed configurations. For the purposes of describing and defining the present invention, it is noted that “punctual” optical beam sources merely comprise lasers or other optical beam sources that define readily distinguishable points of origin and, as such, may comprise any of a variety of conventional or yet-to-be developed optical sources. Additionally, it is noted that a “collimating” lens, as utilized herein, refers to any lens element that tends to increase the collimation of a diverging optical signal and is not limited to ideal or perfect collimating lenses.

As is illustrated schematically in FIG. 1A and explained in further detail below with reference to FIG. 2, the laser source 110, the scanning mirror 120, and the scanning controller 130 are configured such that respective deflections of the first and second optical beams 111, 112 from the scanning mirror 120 are angularly misaligned in the slow scanning axis direction 220 by a dimension d that is tailored to account for respective minimum and maximum inter-pulse delay considerations to satisfy particular safety limits and to optimize performance of the laser projector system in terms of image brightness and image quality. More specifically, according to one embodiment of the present invention, the respective deflections of the first and second optical beams 111, 112 from the scanning mirror 120 are angularly misaligned in the slow scanning axis direction 220 by between approximately one half of the angular extent of a standard eye pupil and approximately one full angular extent of a standard eye pupil. In many cases, the aforementioned misalignment can be achieved by ensuring that the respective deflections of the first and second optical beams are angularly misaligned in the slow scanning axis direction 220 by at least approximately 35 mrad and less than approximately 70 mrad, given a standard pupil location of 100 mm and a standard maximum pupil diameter of 7 mm. According to the previous formula, the distance Δy between the emitters P1, P2 can be adjusted to achieve the aforementioned angular misalignment. As an example, considering a 3 micron diameter emitting point and an image pixel size of 200 microns on a screen located 1 meter away from the projector, the focal length of the lens 115 needs to be around 15 mm. As a consequence, the distance Δy between the emitters P1, P2 needs to be at least 0.53 mm for an angular separation of 35 mrad or 1.05 mm for an angular separation of 70 mrad.

FIG. 2, which shows the image plane 200 and a pupil 250 of an eye schematically, and not necessarily to scale, illustrates the case where the respective deflections of the first and second optical beams 111, 112 are angularly misaligned by the angular dimension d in the slow scanning axis direction 220 by an amount equal to one full angular extent p of a standard eye pupil. In this case, the energy per pulse will oscillate between a minimum value when a given beam spot is at the very edge of the pupil 250 and a maximum value when the spot is centered over the pupil 250.

FIGS. 3 and 4 illustrate the case where the respective deflections of the first and second optical beams 111, 112 are angularly misaligned in the image plane 200 in the slow scanning axis direction 220 by one half of the full angular extent p of a standard eye pupil. In this case, the energy per pulse is nearly kept constant because one beam spot, i.e., that of the second optical beam 202, contributes its maximum energy to the pupil 250 when the other beam spot, i.e., that of the first optical beam 201, contributes its minimum energy to the pupil. In addition, as the first beam spot, i.e., that of the second optical beam 202, moves from the maximum energy position illustrated in FIG. 3, to lower energy position closer to the edge of the pupil 250, as is illustrated in FIG. 4, the second beam spot, i.e., that of the first optical beam 201, moves from the minimum energy position illustrated in FIG. 3, to a higher energy position closer to the center of the pupil 250, as is illustrated in FIG. 4. As a result, the oscillation in energy per pulse will not be as extreme as is the case where the respective deflections of the first and second optical beams 111, 112 are angularly misaligned by the full angular extent p of a standard eye pupil.

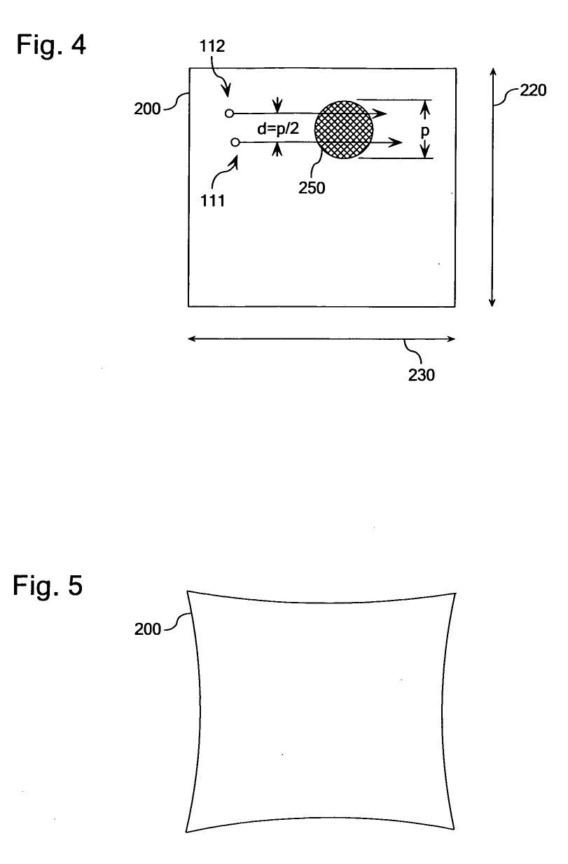

Another important parameter to take into consideration in the design of a laser projection system may be associated with image distortion. Typical scanning-based laser projection systems will present some degree of distortion in the projected image. For example, referring to the image 200 of FIG. 5, the image of a square may not be exactly a square. Accordingly, image distortion algorithms are commonly applied in such systems to compensate for the distortion. Considering the case where multiple optical beams are used that have different incidence angles over the rotating mirror, as is described herein, the problem becomes somewhat more complex. Indeed, the distortion pattern becomes a function of the incidence angle over the rotating mirror. As a consequence, introducing a delay between the optical beams may not be sufficient to insure the co-registration of the images. For example, assuming an angular misalignment of 70 mrad, the difference in the distortion pattern can be around 0.3% of the size of the pattern. Therefore, if the image, for example, is comprised of 1000 lines, the error on the optical beam registration can be about three lines which can considerably degrade the image quality at the edge of the image. As a consequence, in order to insure the proper image quality, distinct image distortion correction algorithms may be needed over each optical beam in order to ensure the image co-registration over the entire surface of the image.

Therefore, by introducing distinct image distortion correction algorithms, maximum exposure factors of a laser projection system can be improved without requiring any additional hardware to the laser projector. In one embodiment, the scanning controller may be programmed to generate a scanned laser image based on a set of image data dedicated to each of the optical beams. The set of image data can be comprised of individual image data portions. Distinct image distortion correction algorithms can be applied to each of the optical beam image data portions. Differences between the distinct image distortion correction algorithms can be a function of the angular misalignment imparted to the optical beams in the slow scanning axis direction.

Similarly, additional complexity may be introduced where a relatively large delay may be required between the optical beams, particularly where the magnitude of the delay would dictate that the scanning controller 130 utilize large sized data buffers. In one embodiment of the present invention, the scanning controller 130 can be programmed to generate a scanned laser image based on a set of image data dedicated to each of the optical beams. The set of image data can be comprised of individual image data portions. The individual image data portions can then be delayed relative to each other by a duration that can be a function of the angular misalignment imparted to the optical beams in the slow scanning axis direction.

It is noted that terms like “preferably,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

For the purposes of describing and defining the present invention it is noted that the term “approximately” is utilized herein to represent the inherent degree of uncertainty that may be attributed to any quantitative comparison, value, measurement, or other representation. The term “approximately” is also utilized herein to represent the degree by which a quantitative representation may vary from a stated reference without resulting in a change in the basic function of the subject matter at issue.

It is noted that recitations herein of a component of the present invention being “programmed” in a particular way, “configured” or “programmed” to embody a particular property, or function in a particular manner, are structural recitations as opposed to recitations of intended use. More specifically, the references herein to the manner in which a component is “programmed” or “configured” denotes an existing physical condition of the component and, as such, is to be taken as a definite recitation of the structural characteristics of the component.

It is noted that one or more of the following claims utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising.”

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

1. A laser projection system comprising a laser source, projection optics, scanning optics, and a scanning controller, wherein:
the laser source comprises at least two punctual sources P₁, P₂;
the first punctual source is configured to produce a first optical beam;
the second punctual source is configured to produce a second optical beam;
the scanning controller is configured to drive the scanning optics to define a fast scanning axis direction in which lines of an image are projected and a slow scanning axis direction in which the optical beams address successive lines of the projected image;
the position of the respective punctual sources relative to each other and to an optical axis of the projection optics provides an angular misalignment of the first and second optical beams downstream of the projection optics; and
the respective punctual sources are positioned such that the first and second optical beams are misaligned in the slow scanning axis direction to a greater extent than in the fast scanning axis direction.

2. The laser projection system of claim 1, wherein the laser source is configured such that positions of the respective punctual sources of the first and second optical beams relative to the projection optics are adjustable.

3. The laser projection system of claim 1, wherein the laser source comprises a multiple emitter, single chip laser diode defining the two punctual sources P₁, P₂.

4. The laser projection system of claim 1, wherein the laser source comprises a frequency-doubled laser comprising a multi-waveguide second harmonic generating crystal.

5. The laser projection system of claim 1, wherein the two punctual sources P₁, P₂ are configured to emit the same wavelength.

6. The laser projection system of claim 1, wherein the two punctual sources P₁, P₂ are configured to emit different wavelengths.

7. The laser projection system of claim 1, wherein the projections optics comprises a collimating lens and the respective punctual sources of the first and second optical beams are positioned on opposite sides of an optical axis of the collimating lens.

8. The laser projection system of claim 1, wherein the respective punctual sources are positioned such that the angular misalignment of the first and second optical beams is aligned with the slow scanning axis direction.

9. The laser projection system of claim 1, wherein the laser source, the scanning optics, and the scanning controller are configured such that respective deflections of the first and second optical beams are misaligned in the slow scanning axis direction by between approximately one half of the angular extent of a standard eye pupil and approximately one full angular extent of a standard eye pupil

10. The laser projection system of claim 1, wherein the laser source, the projection optics, and the scanning optics, are configured such that the first and second optical beams strike a reflective surface of the scanning optics at different angles of incidence in a slow scanning plane defined by the slow scanning axis direction.

11. The laser projection system of claim 10, wherein the first and second optical beams strike the reflective surface of the scanning optics at approximately identical positions.

12. The laser projection system of claim 1, wherein the laser source and the scanning mirror are configured such that respective deflections of the first and second optical beams from the scanning mirror are angularly misaligned in the slow scanning axis direction by at least approximately 35 mrad and less than approximately 70 mrad in a reference frame comprising a standard pupil location of 100 mm.

13. The laser projection system of claim 1, wherein the laser source and the scanning mirror are configured such that the first and second optical beams strike the scanning mirror at different angles of incidence in a slow scanning plane defined by movement of the scanning mirror in the slow scanning axis direction.

14. The laser projection system of claim 1, wherein the laser source and the scanning mirror are configured such that respective deflections of the first and second optical beams from the scanning mirror are angularly misaligned in the slow scanning axis direction to a greater extent than in the fast scanning axis direction.

15. The laser projection system of claim 1, wherein the scanning controller is programmed to:
generate a scanned laser image based on a set of image data comprising a first image data portion dedicated to the first optical beam and a second image data portion dedicated to the second optical beam; and
delay the first and second image data portions relative to each other by a duration that is a function of the angular misalignment imparted to the first and second optical beams in the slow scanning axis direction.

16. The laser projection system of claim 1, wherein the scanning controller is programmed to:
generate a scanned laser image based on a set of image data comprising a first image data portion dedicated to the first optical beam and a second image data portion dedicated to the second optical beam; and
apply distinct image distortion correction algorithms to the first and second image data portions, wherein differences between the distinct image distortion correction algorithms are a function of the angular misalignment imparted to the first and second optical beams in the slow scanning axis direction.

17. A method of operating a laser projection system comprising a laser source, projection optics, scanning optics, and a scanning controller, wherein:
the laser source comprises at least two punctual sources P₁, P₂;
the first punctual source is configured to produce a first optical beam;
the second punctual source is configured to produce a second optical beam;
the scanning controller is configured to drive the scanning optics to define a fast scanning axis direction in which lines of an image are projected and a slow scanning axis direction in which the optical beams address successive lines of the projected image;
the position of the respective punctual sources relative to each other and to an optical axis of the projection optics provides an angular misalignment of the first and second optical beams downstream of the projection optics; and
the respective punctual sources are positioned such that the first and second optical beams are misaligned in the slow scanning axis direction to a greater extent than in the fast scanning axis direction; and
the method comprises adjusting the positions of the respective punctual sources of the first and second optical beams such that respective deflections of the first and second optical beams from the scanning optics are misaligned in the second scanning axis direction by between approximately one half of the angular extent of a standard eye pupil and approximately one full angular extent of a standard eye pupil.
